(19) United States
(12) Patent Application Publication
(10) Pub. No.: US 2008/0085022 A1
(43) Pub. Date: Apr. 10, 2008

(54) Surround Speaker Cabinets

(76) Inventor: Kevin Verlin Polster, Stratford, WI (US)

Correspondence Address: KEVIN POLSTER, M539 HWY 97, STRATFORD, WI, 54484, US

(21) Appl. No.: 11/457,106

(22) Filed: Oct. 6, 2006

(51) Int. Cl. H04R 5/02; H04R 1/02

(52) U.S. Cl. 381/308; 381/335; 381/386

(57) ABSTRACT

Surround Speaker Cabinets, made to project sound in four areas from two-speaker cabinets. Can be used for D.J. or Karaoke Entertainment, Intended for the singer and the audience to hear the music in stereo, using two speaker cabinets.

Speaker cabinets are to be used as a pair, left speaker cabinet and right speaker cabinet hooked up stereo.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APENDIX

Not Applicable

### BACKGROUND OF THE INVENTION

This Invention is intended to improve hearing capability for the singer, or musician, without having to use extra monitor speakers.

Traditionally speaker cabinets have woofers, tweeters, horns midrange speakers on the front of a speaker cabinet, with my new cabinet there is a speaker & horn or tweeter, on the front, and the side, of the trapezoidal shaped cabinet.

### BRIEF SUMARY OF THE INVENTION

As a Disc Jockey & Karaoke Jockey I have experimented with many kinds of acoustical setups over a period of 20 years. To produce the best quality sound with less equipment is my every intention, which is why the idea of the surround speaker cabinets came about.

Typically acoustical setup for karaoke is two speaker cabinets pointing at the audience, one monitor directed at the singer, in mono sound, and in many cases no monitor for the singer at all. With my surround speakers, the fronts of the left and right speaker cabinets in stereo, projecting at the audience, the sides of the speaker cabinets are pointing at the singer with a true stereo sound, enabling the singer to have a quality sound in left ear and right ear.

### BRIEF DESCRIPTION OF THE SEVERAL VIEWS OF THE DRAWING

FIG. 1 is a perspective view of surround speaker cabinets and what they portray.

FIG. 2 is a three-dimensional view of right cabinet, top, front, and left side.

FIG. 3 is a three-dimensional view of left cabinet, top, front and right side.

FIG. 4 is a front and right side view of right cabinet.

FIG. 5 is a front and left side view of left cabinet.

### DETAILED DESCRIPTION OF THE INVENTION

In order to have good quality sound, you must first be able to hear sound, speaker placement is one very important factor. In the past and currently, (for mobile Karaoke jockeys, Disc Jockeys and Musicians,) setting up equipment can be a lot of work, if you want good sound. Two or more speakers pointing at the audience, left and right floor monitor speakers pointing at the entertainer or singer, witch is not the best sound placement to your ears. The best sound to your ears would be headphones or ear monitors, but then you would not be able to hear the audience, and other sounds around you.

Note; Drawings are viewed right to left as if you were standing behind the speakers.

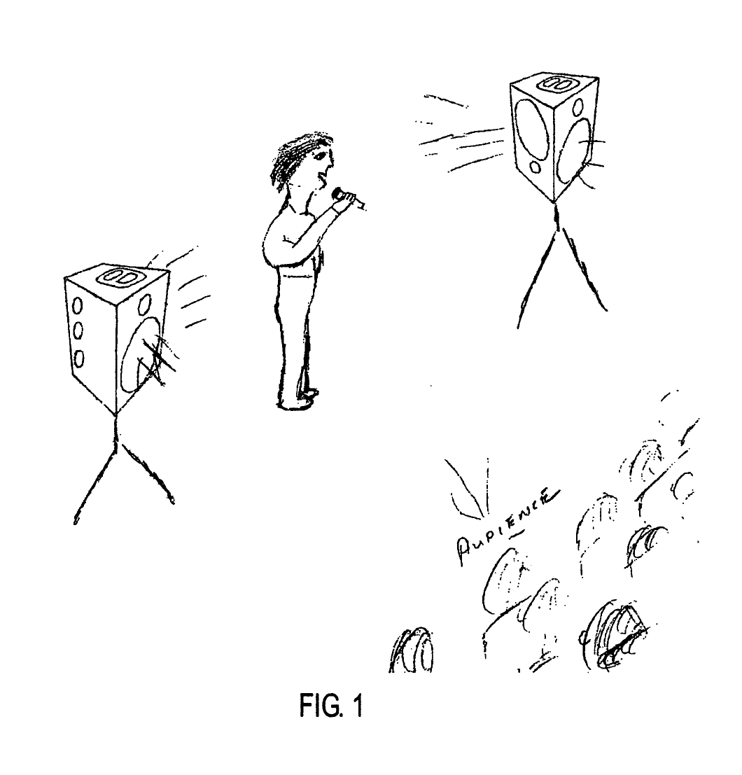

In FIG. 1 the picture displayed, shows left and right stereo sound from sides of speaker cabinets, pointing at the singers left ear and right ear, also being able to hear what is around the area. The front of the left and right speaker cabinet is pointing at the audience in stereo.

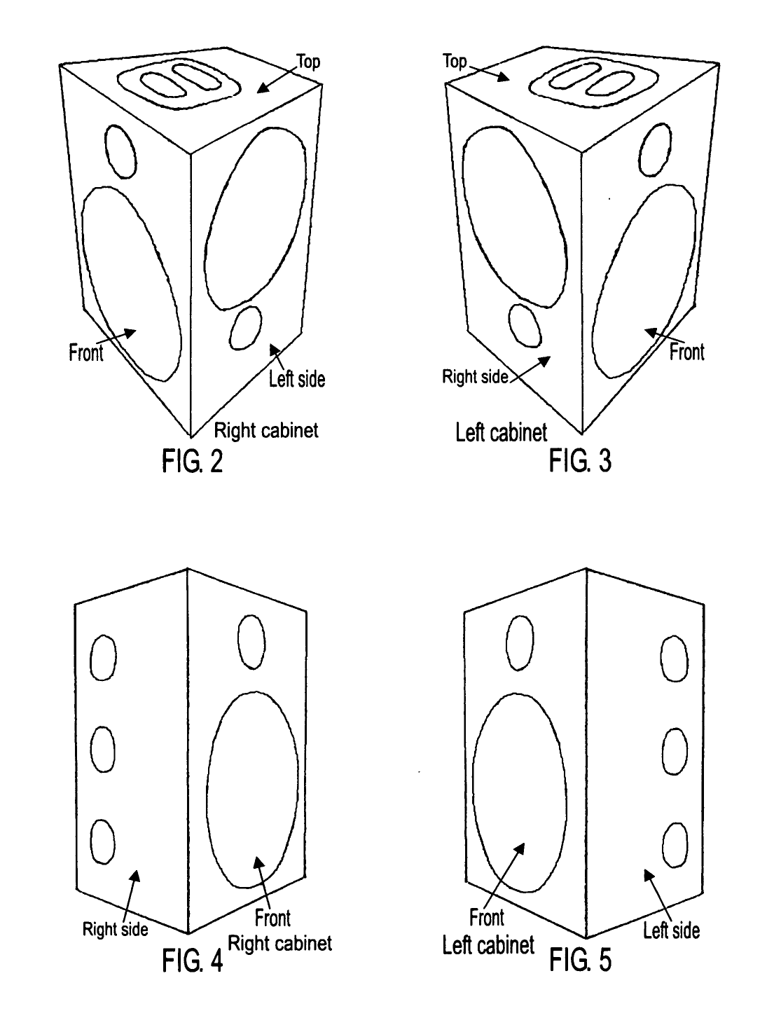

In FIG. 2 the top portion of the right speaker cabinet view shows the easy carrying handle, with the handle positioned on top, the Karaoke Jockey can easily carry one speaker in right hand, and other speaker in left hand when unloading from vehicle to area where speakers will be used.

In FIG. 2 front right speaker cabinet has cut out hole for woofer positioned at bottom, cut out hole for tweeter on top, note: horn may be used in place of tweeter.

In FIG. 2 left side of right speaker cabinet has cut out hole for woofer positioned at top, cut out hole for tweeter on bottom.

In FIG. 3 Left speaker cabinet is identical to right speaker cabinet with sides reversed, meaning left speaker cabinet has side woofer and tweeter on right side of speaker cabinet.

In FIG. 4 right side of right speaker cabinet have 3 two-inch air portholes.

In FIG. 5 left side of left speaker cabinet have 3 two-inch air portholes.

The speaker cabinets as described work as a pair, left and right; dimensions vary according to the size of the woofers used. Speaker cabinets will not exceed thirty inches high, will not exceed nineteen inches wide, and will not exceed fifteen inches deep.

What is claimed is:

1. Surround speaker cabinets comprising: sound waves from two speaker cabinets projecting said sound waves in four areas.

2. Surround speaker cabinets as clamed in clam 1, wherein inner side of said speaker cabinets a woofer and tweeter are mounted.

3. Surround speaker cabinets as clamed in clam 1, wherein top of said speaker cabinets have easy carrying handle.
